(19) United States
(12) Patent Application Publication
(10) Pub. No.: US 2009/0297666 A1
(43) Pub. Date: Dec. 3, 2009

(54) Lolipop and device for the manufacturing thereof

(75) Inventor: Henricus Petrus Maria Neijnens, Haelen (NL)

Correspondence Address: FOLEY & LARDNER LLP, 777 EAST WISCONSIN AVENUE, MILWAUKEE, WI, 53202-5306, US

(73) Assignee: CFS Weert B.V.

(21) Appl. No.: 11/658,050

(22) PCT Filed: Jul. 26, 2005
(86) PCT No.: PCT/NL05/00547

§ 371 Date: Aug. 3, 2009

(30) Foreign Application Priority Data
Jul. 26, 2004 (NL) 1026721
Feb. 17, 2005 (NL) 1028314

(51) Int. Cl. A23G 3/56; B65D 85/60; B65B 11/00

(52) U.S. Cl. 426/75; 426/410; 53/594

(57) ABSTRACT

Lollipop having a head (2) and a stick (1), wherein the lollipop head is packaged in a packaging sheet (3), such as a foil sheet, wherein the packaging sheet forms a seal seam with edges (4, 5) that are joined together and wherein the sheet is sealed on both sides of the head, considered in longitudinal direction, and is twisted at at least one of the longitudinal ends. The seal seam extends over the full distance between both ends.

The invention relates to a lollipop, particularly so-called (double-) twist wrap lollipops. The invention furthermore relates to a method for making such lollipops. The invention furthermore relates to a device for making such lollipops.

It is known to package lollipops in a foil sheet that is placed around the lollipop head and then twisted around the stick and sealed at that location. Such packagings can also be made with a twisted end at the side of the lollipop head that faces away from the stick, which results in a so-called double-twist wrap lollipop.

In case of the known double-twist wrap lollipops a sheet is folded around the head, in order to form a sleeve that is parallel to the stick. The longitudinal edges are brought into overlap with each other, after which the protruding ends of the sleeve are twisted.

An objection to this known packaging is that the overlap forms a passage for air and moisture towards the lollipop material, particularly the sugary mass of the lollipop head. In this way the quality of the lollipop head is affected, resulting in the lollipops being perishable in certain areas in the world.

It is an object of the invention to improve on this.

It is a further object of the invention to provide a lollipop that is easy to open, despite a sealed packaging.

From one aspect the invention provides a lollipop having a head and a stick, wherein the lollipop head is packaged in a packaging sheet, such as a foil sheet, wherein the packaging sheet forms a seal seam with edges that are joined together and wherein the sheet is sealed on both sides of the head, considered in longitudinal direction, and is twisted at at least one of the longitudinal ends.

In the lollipop according to the invention the head has been sealed from the ambience by the seal seam(s) and the at least one twisted area. In this way the quality, texture and taste of the lollipop mass is preserved. Due to the integrity of the packaging when the seal seam has been formed the lollipop head can, if necessary, be engaged for enhancing the twisting, without an opening in the packaging being created.

Preferably the seal seam extends between both ends, so that the seal seam is in one plane with the stick.

The seal seam may extend over the full distance between both ends, which results in an optimal sealing. The exact location (considered in stick direction) of the twisted area(s) is of less importance in that case.

Preferably the seal seam forms a strip that can be engaged on both sides by the fingers of a hand, which may enhance the opening of the packaging. Opening is further enhanced if the seal seam is provided with a local discontinuity or weakening, where tearing the packaging open can be initiated. The twisted areas need not be touched in that case.

In one embodiment the sheet is made of synthetic material, such as polypropylene, having a layer of sealable material. Said layer preferably is sealable, such as by heat and/or pressure (such as for instance a cold seal).

In one embodiment the sheet is twisted and sealed at both opposite ends, in order to form a so-called twist-wrap lollipop.

In one embodiment the packaging sheet is sealed at the location of the transition from the head to the stick. Preferably the packaging sheet is then twisted at the location of the transition from the head to the stick.

Preferably the packaging sheet is twisted at the longitudinal end facing away from the stick.

From a further aspect the invention provides in a more generally described lollipop, which lollipop comprises a head enveloped by a sheet-shaped packaging, wherein the packaging is twisted and sealed around the stick and behind the head, wherein the sheet is provided with a weakening or discontinuity for opening the packaging by tearing the sheet.

From a further aspect the invention provides a method for packaging a lollipop in a sheet of packaging material, such as a foil sheet, wherein the packaging sheet is placed around the lollipop in order to form a sleeve parallel to the stick, wherein the longitudinal edges of the sleeve are sealed together and at least one of the sections of the sleeve protruding towards the opposite sides of the head is twisted and both protruding sections are sealed.

Preferably prior to sealing the longitudinal edges are placed with their inner surfaces against each other.

Alternatively prior to sealing the longitudinal edges are placed with their inner surfaces and outer surfaces, respectively, against each other. The foil can then be provided with a sealable layer at the outer surface or at the inner surface.

Preferably the sealed longitudinal edges form a strip, which strip is laid against the sleeve.

The longitudinal edges and/or twisted areas can be sealed by hot air.

As indicated above the sealed longitudinal edges can be—or are—provided with a discontinuity or weakening.

From a further aspect the invention provides a device for packaging lollipops provided with a stick and a head, comprising means for holding the lollipops, means for supplying packaging material in the form of sheets, such as foil sheets, and means for placing the packaging sheet in question around the lollipop, wherein the packaging sheet is bent about a longitudinal centre line that is substantially parallel to the stick, furthermore provided with means for bringing the opposite longitudinal edge areas of the packaging sheet against each other, and means for sealing both longitudinal edge areas together while forming a foil tube, wherein the device furthermore comprises first and/or second means for twisting one or both foil tube sections protruding from the longitudinal sides of the lollipop head. With such a device a double-twisted and sealed lollipop packaging can be efficiently achieved.

The sealing of the packaging can be optimised if the sealing means have a length corresponding with at least almost the length of the longitudinal edge areas of the packaging sheet.

In one embodiment the sealing means are adapted for heat sealing.

In a further embodiment the first and second twisting means are rotatable in the same direction.

The first twisting means preferably are positioned for twisting the foil section in question around the stick.

In one embodiment the means for placing the packaging sheet around the lollipop are adapted for placing the longitudinal edge areas with their inner sides against each other.

In a simple and fast-working embodiment the sealing means are part of the means for placing the packaging sheet around the lollipop.

Preferably the means for placing the packaging sheet around the lollipop and/or the sealing means are provided with cooperating means, such as a blade and an anvil, for forming a weakening or recess in both longitudinal edge areas.

From a further aspect the invention provides a device for packaging lollipops provided with a stick and a head, comprising means for holding the lollipops, means for supplying packaging material in the form of sheets, such as foil sheets, and means for placing the packaging sheet in question around the lollipop, wherein the packaging sheet is bent about a longitudinal centre line that is substantially parallel to the stick, furthermore provided with means for clamping the lollipops on the head with the foil in between, wherein the device furthermore comprises first and/or second means for twisting one or both foil tube sections protruding from the longitudinal sides of the lollipop head, during continued clamping of the lollipop head.

Preferably the device is furthermore provided with means for bringing opposite longitudinal edge areas of the packaging sheet against each other, and means for sealing both longitudinal edge areas together, while forming a foil tube, prior to twisting.

The invention will be elucidated on the basis of an exemplary embodiment shown in the attached drawings, in which:

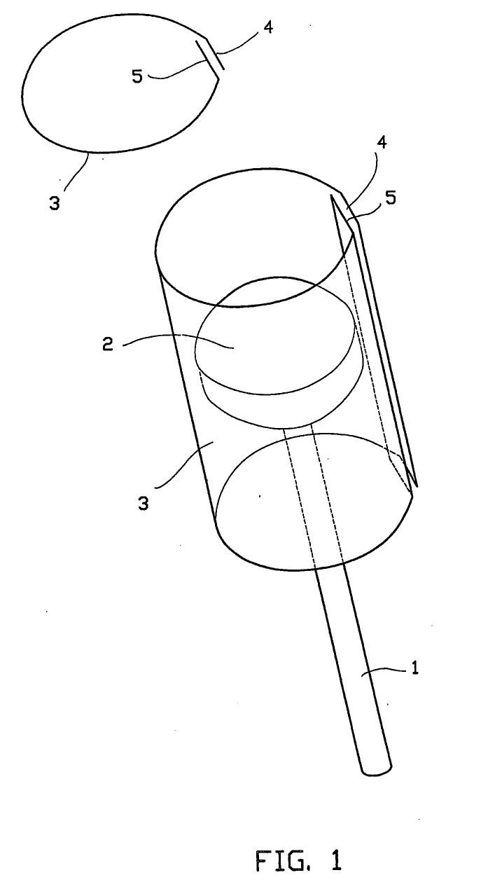

FIG. 1 shows a double-twist wrap lollipop according to the state of the art, at a moment during manufacturing;

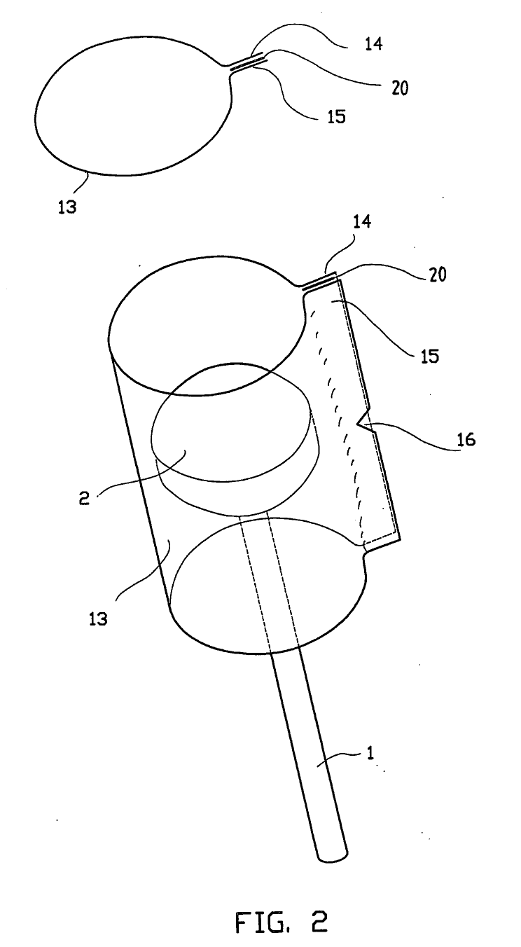

FIG. 2 shows a double-twist wrap lollipop according to the invention at the same stage as FIG. 1;

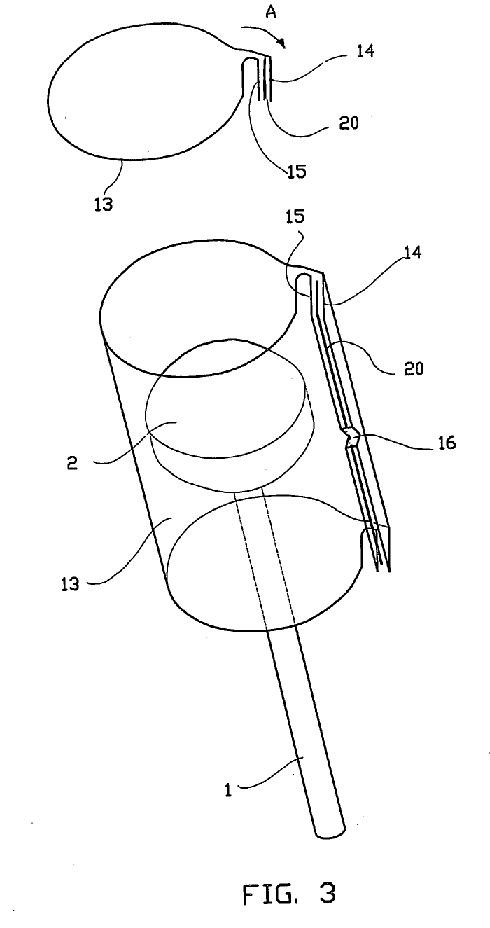

FIG. 3 shows the double-twist wrap lollipop of FIG. 2 at a next stage;

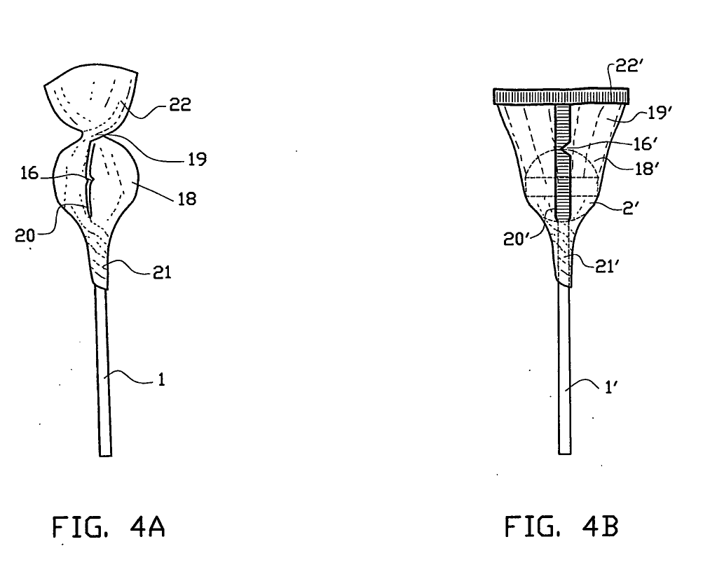

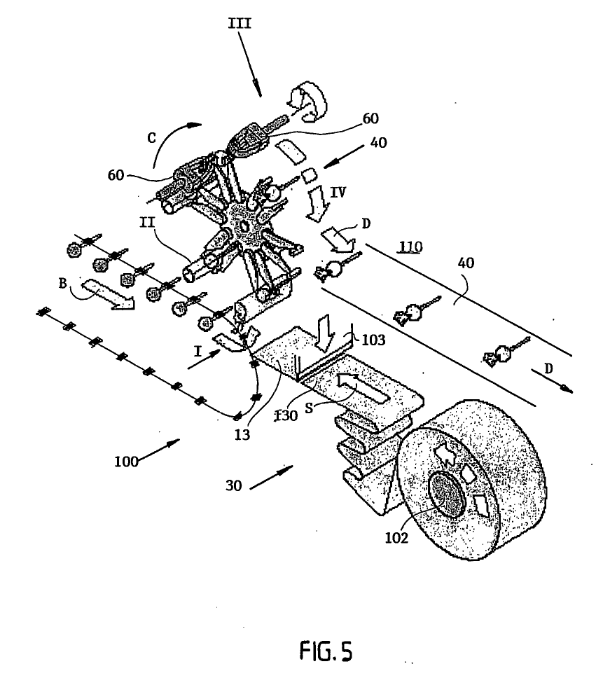

FIG. 4A shows a double-twist wrap lollipop according to the invention, ready;

FIG. 4B shows an alternative embodiment of a lollipop according to the invention;

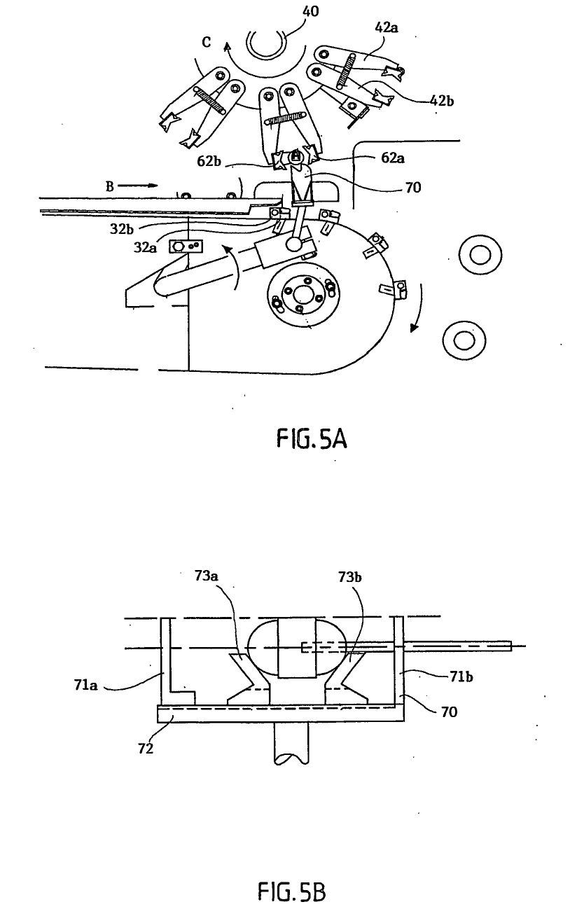

FIG. 5 shows a schematic view in perspective of a part of a packaging device for making lollipops according to FIGS. 2-4A;

FIGS. 5A and 5B show a schematic view of a transfer station in the device of FIG. 5;

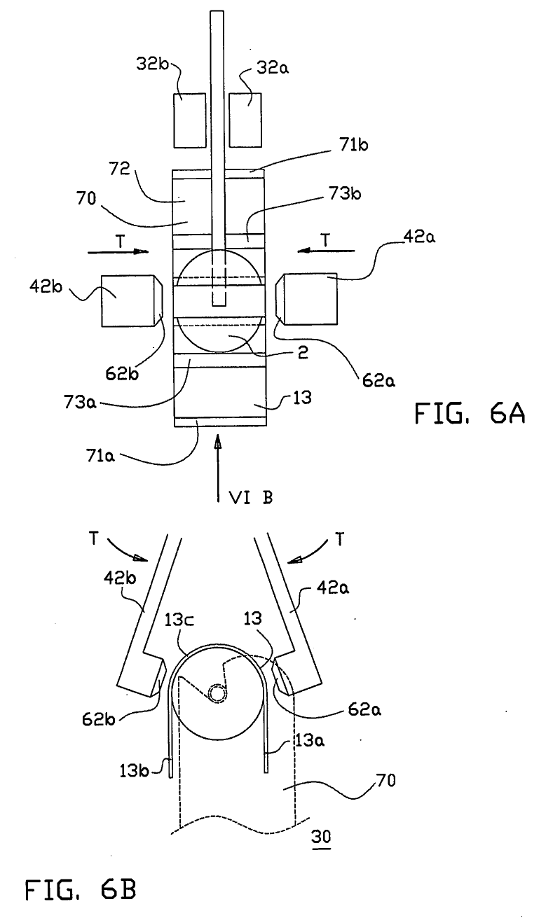

FIGS. 6A and 6B show a schematic view, transverse to the lollipop stick and in its extension, respectively, at a first packaging stage;

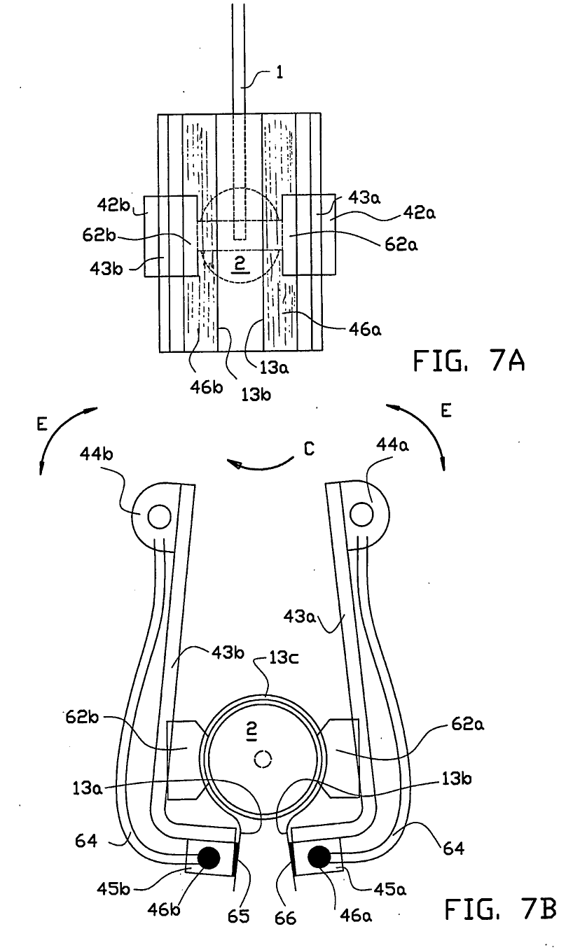

FIGS. 7A and 7B show a schematic view, transverse to the lollipop stick and in its extension, respectively, at a second packaging stage;

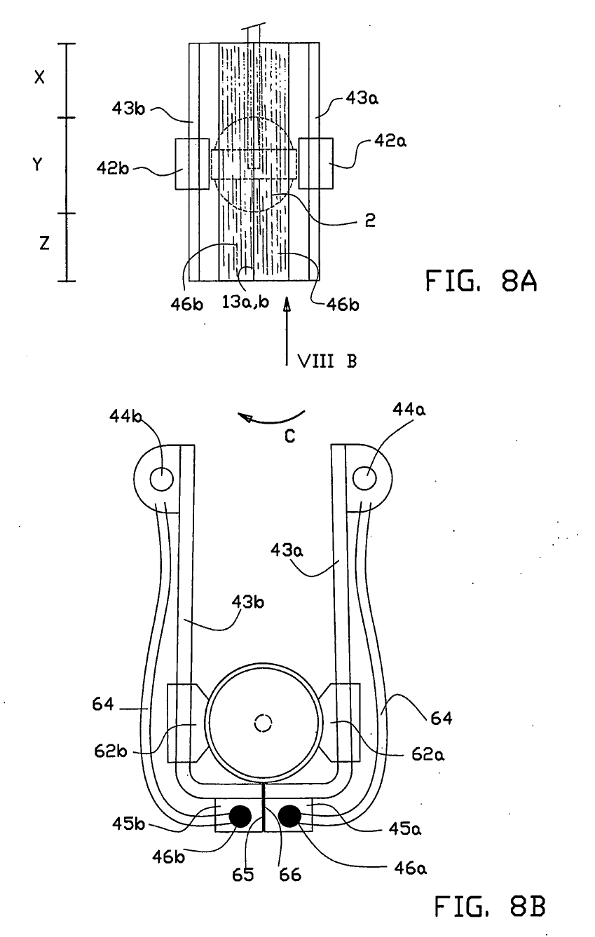

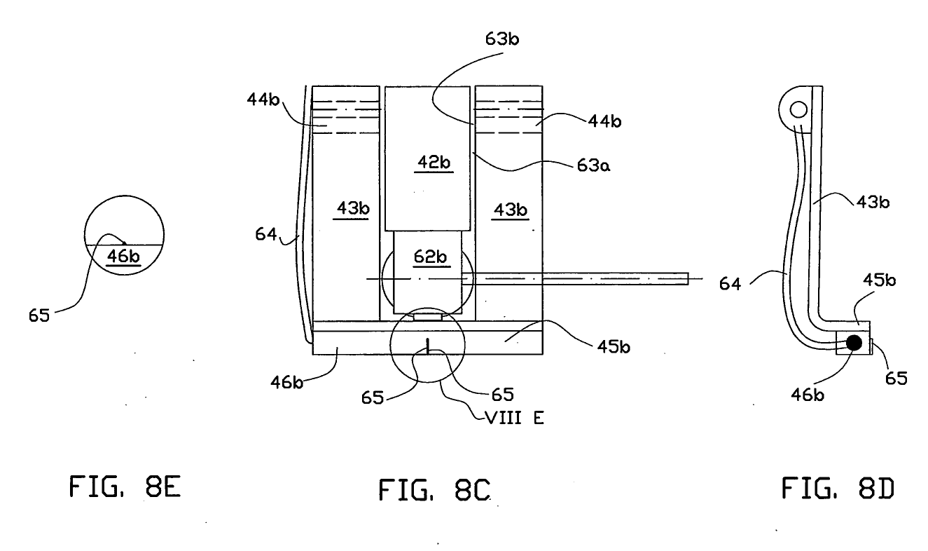

FIGS. 8A and 8B show a schematic view, transverse to the lollipop stick and in its extension, respectively, at a third packaging stage;

FIGS. 8C, 8D and 8E show an end view and side view of a sealing arm and a detail of the sealing surface of said sealing arm, respectively, in the packaging device of FIG. 5;

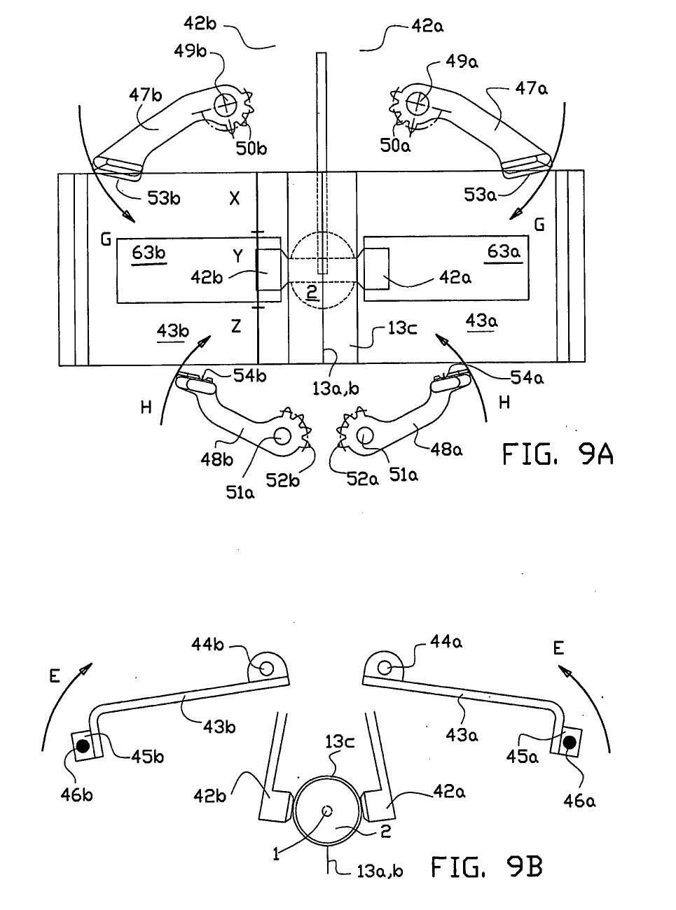

FIGS. 9A and 9B show a schematic view, transverse to the lollipop stick and in its extension, respectively, at a fourth packaging stage; and

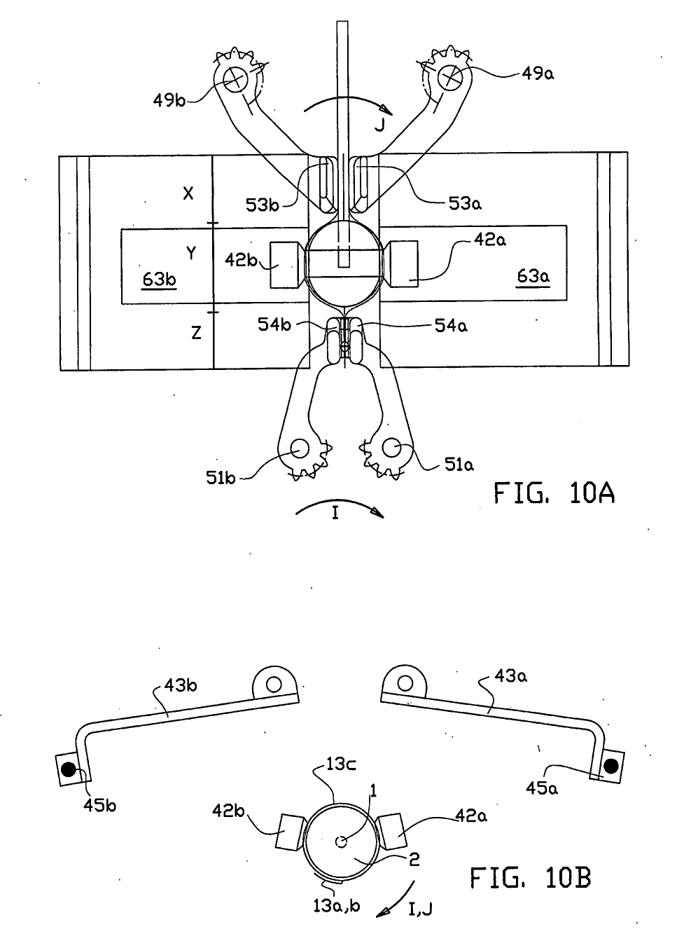

FIGS. 10A and 10B show a schematic view, transverse to the lollipop stick and in its extension, respectively, at a fifth packaging stage.

The lollipop shown in FIG. 1 comprises a stick 1 and a lollipop head 2, which, at a packaging stage, are enveloped by a foil sheet 3, of which, as shown at the top section of FIG. 1, the edges 4 and 5 have been placed over each other for forming a sleeve, which further down the process is twisted above the head 2 and below the head 2 around the stick 1. The edges 4 and 5 that overlap each other may shift with respect to each other. After the packaging has been completed a passage may have been formed between the edges 4 and 5 through which air and moisture may get to the lollipop head 2, which adversely affects the quality of the lollipop.

In one suggestion according to the invention, shown in FIGS. 2-4, the foil sheet 13, for instance made of polypropylene provided with a heat sealable layer, is transformed into an actual sleeve, without slit, wherein the edges 14 and 15 under the influence of heat, for instance by hot blow air, are sealed into an airtight and moisture proof seal edge 20. The seal edge 20 may be provided with a weakened area, particularly a notch 16, for initiating a tearing opening movement of the enveloping of the lollipop.

As can be seen in FIG. 3 the seal edge 20 is subsequently folded to lie flat against the sleeve-shaped packaging formed by sheet 13.

In the condition of FIG. 3 the foil sleeve closed in circumferential direction can be twisted at both longitudinal ends of the lollipop head 2 in the manner known per se, and be sealed as well, again for instance using hot blow air. Thus the sealed twisted areas 19 and 21 are formed (FIG. 4A), wherein at the free end a wing 22 is integrally formed. The head 2 is then enveloped by foil section 18, wherein the flat, turned seal edge 20 is accessible to a finger of the user, who is able to lift said edge, subsequently tear it open at the location of weakening 16 to subsequently take the lollipop out of the packaging.

The weakening or discontinuity may under certain circumstances also be formed by a tearing strip.

The lollipop according to FIG. 4A with the discussed packaging may preserve its quality for a long time, also in areas where with the packagings that have been common up until now the quality of the lollipops deteriorates very quickly.

The same applies to the lollipop shown in FIG. 4B, in which only one end section of the foil sleeve has been twisted. The head 2′ is enveloped by foil section 18′, and provided with longitudinal seal 20′ with weakening 16′. Below the head 2′ the foil tube is twisted (21′), yet above the head 2′ the foil tube is untwisted in fan-shaped, flat flaring section 19′, yet transversely sealed at the location of seam 22′.

The (part of) packaging device 100 shown in FIG. 5 comprises a schematically shown supply device 30 for a web of packaging foil 130, which is unrolled from a supply roll 102 and driven in the direction S and cut into pieces of foil sheet 13 by means of blades 103. The cut off foil sheets 13 are intermittently discharged to a series of lollipops supplied in direction B in conveyance clamps 32a,b, as known per se from the applicant's commercially available machine TwistWrapper 300. Each lollipop including a foil sheet 13 is consecutively received in a wheel 40, driven in the direction C about a horizontal centre line. The transfer is schematically shown in FIGS. 5A and 5B. Transfer device 70 moving up and down, takes the lollipops from the conveyance clamps 32a,b opened at that location wherein the lollipop head is supported on support members 73a,b and the stick on support member 71b, which support members with the member 71a are attached to support plate 72 of the transfer device 70. Between the support members 73a,b there is room for engagement of the head by clamping members 62a,b that are attached to wheel 40.

As is also schematically shown in FIG. 6B the lollipops in supply B are held clamped on the sticks by pairs of clamping jaws 32a, 32b. The second wheel 40 is provided with a series of lollipop holders 60, that circulate along with the second wheel 40 in the direction C.

In the second wheel 40 a number of stations can be distinguished in the circulation, namely station I, where the lollipops including foil sheets are accommodated, station or track II where the foil sheet 13 is placed around the lollipop head and sealed longitudinally, station III where twisting takes place and station IV where the packaged and twisted lollipop is discharged in the direction D to a discharge station 110.

The lollipop holders 60 arranged on the disc 40 have a number of lollipop head clamping arms 42a, 42b, provided with clamping members 62a,b and furthermore hingingly driven (in a manner not shown) in the wheel 40, in order to be brought in and out of clamping engagement of the head of a lollipop.

The lollipop holders 60 furthermore comprise sealing arms 43a, 43b, which, as can be seen in FIG. 7B, are hingingly attached on the second wheel 40 at the location of hinges 44a, 44b, and are L-shaped with sealing rods 45a, 45b, in which heating elements 46a, 46b have been arranged. On sealing rod 45b (see FIG. 8E) a blade 65 has been provided that is able to cuttingly cooperate with an anvil 66 on sealing rod 46a. The blade 65 does not extend over the full height of the sealing rod 46a, but ends at a distance from the edge of the sealing rod that is situated at the lollipop side. As is also indicated in FIG. 8D a heating wire 64 extends to heating element 46b for actuating it. The wire 64 extends to hinge 44b, in order to be connected there to further electric wires that are not further shown.

As further shown in FIGS. 9A and 10A two pairs of twisting arms 47a, 47b and 48a, 48b are positioned at the location of station III, which arms are rotatably attached in manner that is not shown at the location of hinges 49a, 49b and 51a, 51b in order to be rotated in the directions G and H. The twisting arms 47a, 47b and 48a, 48b are provided with teeth 50a, 50b and 52a, 52b near their hinge end for cooperation with a drive rack (not further shown) in order to be able to carry out the said rotation.

At their other ends the twisting arms 47a, 47b and 48a, 48b are provided with foil engagement surfaces 53a, 53b and 54a, 54b. The twisting arms 47a, 47b are provided with an opening 63a,b to offer room to the sealing arms 43a, 43b, also see FIG. 8C.

In the partial track I the treatment shown in FIGS. 6A and 6B takes place. The stick of the lollipop is still clamped by the clamping arms 32a, 32b of the supplier. The clamping arms 42a, 42b of the second wheel 60 rotate inwards, and with the clamping members 62a,b start clamping the lollipop on the head, with the foil sheet 13 in between. Then the clamping arms 32a, 32b of the supplier are released. The lollipop is then only held on the wheel 40.

Immediately subsequent, while rotating in direction C, in partial track II, the sealing arms 43a, 43b are rotated towards each other in the direction E. The sealing rods 45a, 45b with the heating elements 46a, 46b contact the pending foil sheet areas 13a, 13b and bring them towards each other, as can be seen in FIG. 7B.

This movement is continued until the foil sheet areas 13a, 13b touch each other and the sealing rods 45a, 45b of the sealing arms 43a, 43b extend just below the head 2 of the lollipop. The sealing arms 43a, 43b here also function as (part of the) means for placing the foil sheet fully around the lollipop.

In addition or subsequently the heating elements 46a, 46b are activated and the foil areas 13a, 13b are sealed together, see FIG. 8B.

Then a foil tube 13 closed by sealing is achieved, which fully surrounds the lollipop head 2 in partial area Y (see FIGS. 8A, 9A), and protruding therefrom in longitudinal direction of the tube in foil tube edge areas X and Z.

Subsequently the sealing arms 43a, 43b can be moved apart in the direction E (see FIG. 9B), and the lollipop holders 60 arrive at twisting station III. At that location the wheel 40 is held still and the twisting arms 47a, 47b and 48a, 48b are rotated in the direction G and H in order to fixedly clamp the respective foil tube sections X and Z between the twisting surfaces 53a, 53b and 54a, 54b. The stick, however, remains clamped at all times between the clamping arms 42a, 42b, on the head, including the foil.

Subsequently the twisting arms 47a,b and 48a,b are rotated in the directions I and J, as schematically shown in FIG. 10A, about a centre line coinciding with the centre line of the stick. The clamping arms 42a, 42b here do not rotate any longer, so that the foil tube 13 is rotated, wherein the foil tube section X is twisted around the stick and the foil tube section Z is twisted into a fan-shaped knot. During twisting the twisting arms 47a,b and 48a,b will be moved slightly towards the lollipop head in the manner known per se (TwistWrapper 300).

Because of the twisted ends and the sealing seal continuing therein the lollipop head 2 will be fully closed off from the ambience.

After the twisting arms 47a, 47b and 48a, 48b have been removed from the lollipop including foil and have at least been slightly rotated back again the wheel 40 is rotated further and the packaged lollipop is discharged in station IV in direction D to a discharge station 110, after the clamping arms 42a, 42b have been opened.

1-31. (canceled)

32. A lollipop, comprising:
a stick;
a head coupled to the stick and having a top end facing away from the stick and a bottom end opposed to the top end; and
a packaging sheet, wherein the head is packaged in the packaging sheet;
wherein two edges of the packaging sheet are joined together to form a seal seam in a longitudinal direction extending from the top end of the head to the bottom end of the head and wherein the sheet is twisted at at least one of the ends of the head.

33. The lollipop of claim 32, wherein the seal seam extends the entire length of the sheet.

34. The lollipop of claim 32, wherein the seal seam forms a strip that can be engaged on both sides by the fingers of a hand.

35. The lollipop of claim 32, wherein the seal seam is provided with a local discontinuity or weakening to facilitate tearing of the sheet.

36. The lollipop of claim 32, wherein the sheet is made of a synthetic material having a layer of sealable material.

37. The lollipop according to claim 36, wherein the layer of sealable material is sealable via heat or pressure.

38. The lollipop of claim 32, wherein the packaging sheet is sealed at the bottom end of the head.

39. The lollipop according to claim 38, wherein the packaging sheet is twisted at the bottom end of the head.

40. The lollipop of claim 32, wherein the packaging sheet is twisted at the top end of the head.

41. A lollipop having a head enveloped by a sheet of packaging, wherein the packaging is twisted and sealed around the stick and behind the head, wherein the sheet is provided with a weakening or discontinuity for opening the packaging by tearing the sheet.

42. A method for packaging a lollipop, comprising:
providing a stick having a lollipop head coupled thereto;
providing a sheet of packaging material;
wrapping the sheet around the lollipop to form a sleeve parallel to the stick, the sleeve having a first end and a second end and two longitudinal edges;
sealing the longitudinal edges of the sleeve together;
twisting the first end of the sleeve to form a seal adjacent the head; and
sealing the second end of the sleeve.

43. The method of claim 42, wherein prior to sealing the longitudinal edges of the sleeve, the longitudinal edges are placed with their inner surfaces against each other.

44. The method of claim 42, wherein prior to sealing the longitudinal edges of the sleeve, the longitudinal edges are placed with their inner surfaces and outer surfaces, respectively, against each other.

45. The method of claim 42, wherein the sealed longitudinal edges form a strip, wherein the strip is laid against the sleeve.

46. The method of claim 42, wherein the longitudinal edges are sealed by hot air.

47. The method of claim 42, further comprising sealing the twisted portion of the sleeve by applying hot air.

48. The method of claim 42, wherein the sealed longitudinal edges are provided with a discontinuity or weakening.

49. A lollipop having a head and a stick, wherein the lollipop head is packaged in a packaging sheet, wherein the packaging sheet with opposite edges forms a seal seam, and wherein the sheet at the location of a transition from the head to the stick and at the opposite side of the head is twisted and sealed.

50. A device for packaging lollipops having a stick and a head, comprising:
means for holding a lollipop;
means for supplying packaging material in the form of a sheet;
means for placing the sheet around the lollipop, wherein the sheet is bent about a longitudinal center line that is substantially parallel to the stick;
means for bringing opposite longitudinal edge areas of the packaging sheet against each other;
means for sealing the longitudinal edge areas together to form a tube; and
first means for twisting a portion of the tube extending beyond one of the longitudinal sides of the lollipop head.

51. The device of claim 50, wherein the means for sealing has a length of approximately the length of the longitudinal edge areas of the packaging sheet.

52. The device of claim 50, wherein the means for sealing is adapted for heat sealing.

53. The device of claim 50, further comprising a second means for twisting a portion of the tube extending beyond one of the longitudinal sides of the lollipop head, wherein the first and second means for twisting rotate in the same direction.

54. The device of claim 50, wherein the first means for twisting is positioned for twisting the tube around the stick.

55. The device of claim 50, wherein the means for placing the packaging sheet around the lollipop is adapted for placing the longitudinal edge areas with their inner sides against each other.

56. The device of claim 50, wherein the means for sealing is part of the means for placing the packaging sheet around the lollipop.

57. The device of claim 50, wherein the means for placing the packaging sheet around the lollipop and/or the means for sealing are provided with cooperating means for forming a weakening or recess in both longitudinal edge areas.

58. A device for packaging lollipops provided with a stick and a head, comprising:
means for holding a lollipop;
means for supplying packaging material in the form of a sheet;
means for placing the sheet around the lollipop, wherein the sheet is bent about a longitudinal center line that is substantially parallel to the stick;
means for clamping the lollipop on the head with the sheet in between the means for clamping; and
means for twisting a portion of the sheet extending past one of the longitudinal sides of the lollipop head during continued clamping of the lollipop head.

59. The device of claim 58, further comprising means for bringing opposite longitudinal edge areas of the packaging sheet against each other; and
means for sealing both longitudinal edge areas together to form a foil tube prior to twisting.
